(19) United States
(12) Patent Application Publication
(10) Pub. No.: US 2025/0288085 A1
(43) Pub. Date: Sep. 18, 2025

(54) NOVAL PHONE HOLDER

(71) Applicant: Humphrey Wesenhagen, Marana, AZ (US)

(72) Inventor: Humphrey Wesenhagen, Marana, AZ (US)

(21) Appl. No.: 18/603,551

(22) Filed: Mar. 13, 2024

(51) Int. Cl. A45F 5/02; H04M 1/04

(52) U.S. Cl. CPC A45F 5/021; H04M 1/04; A45F 5/1516

(57) ABSTRACT

Presented is a phone holder removably attachable to a seat belt for holding an electronic device. The phone holder includes a base portion with a first surface, an opposed second surface, an upper edge, a lower edge, and a pair of side edges extending between the upper and lower edges. The phone holder further includes one or a pair of electronic device holder clips configured to retain the electronic device between the second surface of the base portion, and a curved inner portion of the electronic device holder clips. Further, the phone holder includes a belt clip attached in proximity to the lower edge on the first surface. The first surface of the base portion and the inner surface of the at least one belt clip are configured to removably secure the phone holder over the seat belt, when the seat belt is passed therethrough.

### FIELD OF THE INVENTION

The present application generally relates to phone holders, more particularly the present invention relates to a noval phone holder device removably attachable to a seat belt of an automobile or straps of a backpack, shirt, and the like for holding an electronic device such as a mobile phone.

### BACKGROUND

Many jurisdictions in the United States are placing legal restrictions on the operation of a mobile phone by a driver driving an automobile. One of the challenging job for a driver is to converse with a person on a phone especially when the driver is riding the automobile. Currently, the automobile driver uses mounts or hardware for mounting their mobile phone on the dashboard of the automobile. In the event of receiving a call from a third party, the driver receives the call either by pressing the buttons provided on the phone or using control buttons mounted on the steering. However, due to high speeding vehicles nearby, wind conditions, and noise from own automobile, at times, conversation, it becomes very hard for the driver to listen to the person on the other side of the phone. Likewise, when the user has to talk to the people on the other side of the phone, usually the driver needs to either speak aloud, slow down his vehicle, or stop on the side of the road to communicate or converse so that the other person can clearly understand what the driver converses with the person. Speaking loudly on the phone can drain out the driver's energy and may be annoying for the other co-passengers traveling in the same automobile. All of these issues are generally due to the distance between the speaker and the microphone of the mobile phone from the driver. Although, existing mounts or hardware assemblies are effective for their intended purposes, however, they are more likely permanently attached top dashboard and can't be easily removed for remote uses by the driver.

Various “hands-free” systems have adopted technological fixes; examples include the use of ear mounted devices that communicate with a mobile phone located nearby and the use of headphones with a microphone or earpieces in combination with a microphone (mic). However, in such prior devices, the user must remember to carry the appropriate hardware and must take the time to install the hardware before beginning the operation of the motor vehicle. Thus, there remains a significant and as yet unmet need for a mobile phone support configuration that would allow easy and quick location of the cell phone near the user's mouth and ears that nevertheless would allow the driver to perform “hands-free” speaking (using phone's mic) and listening (using phone's speaker) while conversing with a person during any call.

Therefore, it would be desirable to have an accessory configured in the form of a phone holder that may be conveniently mounted to a driver's seatbelt or straps of the backpacks or any other similar applications that would enable drivers to converse more conveniently without having to speak louder and without having to hold the phone near mouth or ears using his/her hand. Further, it would be desirable to have a seat belt attachment that would allow a mobile phone to be removably held at a selected position on the seat belt and removed when the driver exits the vehicle. In addition, it would be desirable to have a seat belt attachment that may itself remain attached to a seatbelt after the mobile phone has been removed.

### SUMMARY

Embodiments of the present invention describe a phone holder removably attachable to a seat belt of an automobile or straps of a backpack or the like for holding an electronic device. The phone holder includes a base portion substantially planar and having a first surface and an opposed second surface. The base portion further comprises an upper edge and a lower edge, and a pair of side edges extending between the upper and lower edges. The base portion is substantially rectangular in shape with at least rounded corners or pointed corners.

In an embodiment, the phone holder further includes a pair of electronic device holder clips, each of the pair of holder clips is fixedly attached in proximity to the upper edge on the second surface, each of the pair of electronic device holder clips is configured to retain the electronic device between the second surface of the base portion, and a curved inner portion of the electronic device holder clips. The pair of electronic device holder clips have a flexible configuration that is biased toward an opposed second surface to secure the electronic device between the pair of electronic device holder clips and the second surface of the base portion.

In an embodiment, the phone holder further includes at least one belt clip with an outer surface and an inner surface, wherein the at least one belt clip is fixedly attached in proximity to the lower edge on the first surface. The at least one belt clip extends along the entire length between the pair of side edges. The at least one belt clip extends partially along between the pair of side edges. The at least one belt clip extends exact to the height of the base portion. The at least one belt clip extends beyond the height of the base portion.

In an embodiment, the first surface of the base portion and the inner surface of the at least one belt clip are configured to removably secure the phone holder over the seat belt, when the seat belt is passed therethrough.

In an embodiment, the first surface of the base portion is curved or inclined extending from the lower edge to the upper edge between the pair of side edges. In another embodiment, the first surface of the base portion comprises a ramp configured thereon. The ramp is curved or inclined and extends between the lower edge, and an upper edge. The ramp is thicker at the lower edge and thinner at the upper edge of the base portion. The ramp is disposed of in midway between the pair of side edges. The ramp further comprises a thumb support configured at one end thereof to facilitate removal of the clipped-on electronic device from the phone holder.

In an embodiment, the at least one belt clip is at least substantially flat and substantially similar in shape to that of the base portion. In another embodiment, the at least one belt clip is U-shaped with formed using two vertical arms (V1, V2) and a horizontal arm (H1).

In an embodiment, each of the pair of holder clips is substantially L-shaped and comprises an upwardly extending portion, and the curved inner portion. An end of the upwardly extending portion of each of the pair of holder clips is attached in proximity to the upper end on the second surface, and the other end is connected to the curved inner portion.

These and other features and advantages of the present invention will become apparent from the detailed description below, in light of the accompanying drawings.

### BRIEF DESCRIPTION OF ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a front perspective view of a phone holder device removably attachable to a seat belt, according to an exemplary embodiment of the present invention.

FIGS. 2 and 6 are diagrams that illustrate a front view, a rear view, a side view, a top view, and a bottom view of the phone holder device of FIG. 1 respectively.

FIG. 7A is a diagram that illustrates a front perspective view of the phone holder device removably attachable to a seat belt, according to another exemplary embodiment of the present invention.

FIG. 7B is a diagram that illustrates a front perspective view of the phone holder device removably attachable to a seat belt, according to yet another exemplary embodiment of the present invention.

FIG. 8 is a diagram that illustrates a front perspective view of the phone holder device removably attachable to a seat belt, according to yet another exemplary embodiment of the present invention.

FIGS. 9-13 are diagrams that illustrate a front view, a rear view, a side view, a top view, and a bottom view of the phone holder device of FIG. 8 respectively.

FIG. 14 is a diagram that illustrates the phone holder device removably attachable to a seat belt of an automobile and in use, according to an embodiment.

FIG. 15 is a diagram that illustrates the phone holder device removably attachable to the right upper front body area of a shirt worn by the user and in use, according to another embodiment.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted in one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a phone holder device removably attachable to a seat belt. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed apparatuses have been described below, it should be understood that they have been presented for purposes of example only, and not limitations. It is not exhaustive and does not limit the present invention to the precise form disclosed. Modifications and variations are possible in light of the below teachings or may be acquired from practicing of the present invention, without departing from the breadth or scope.

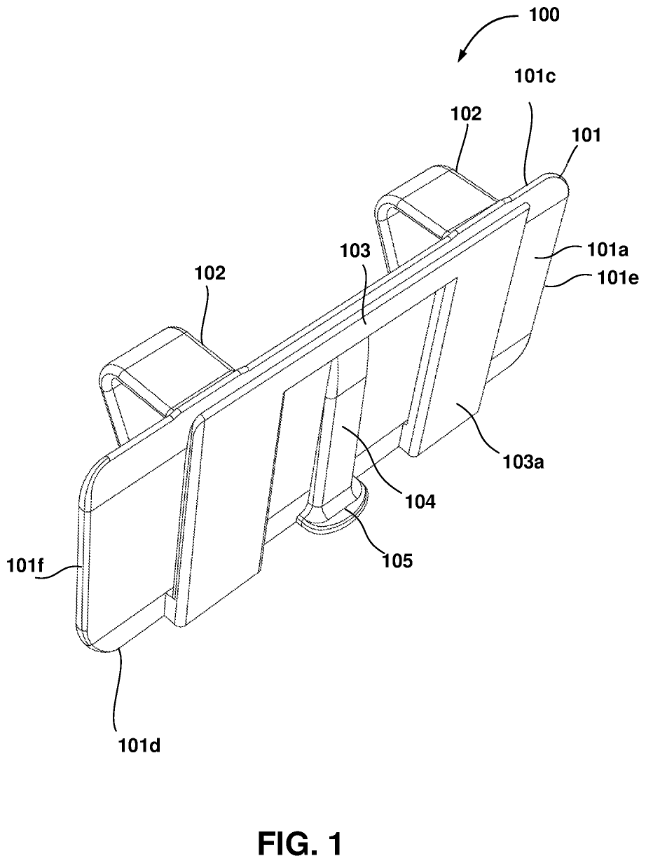

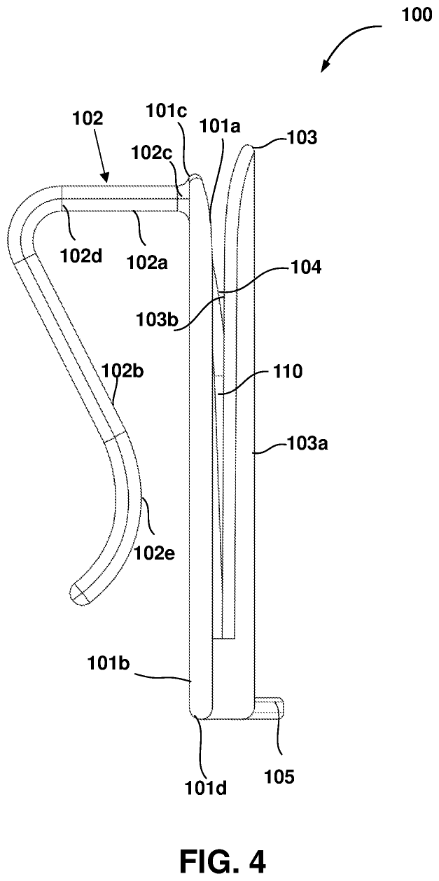

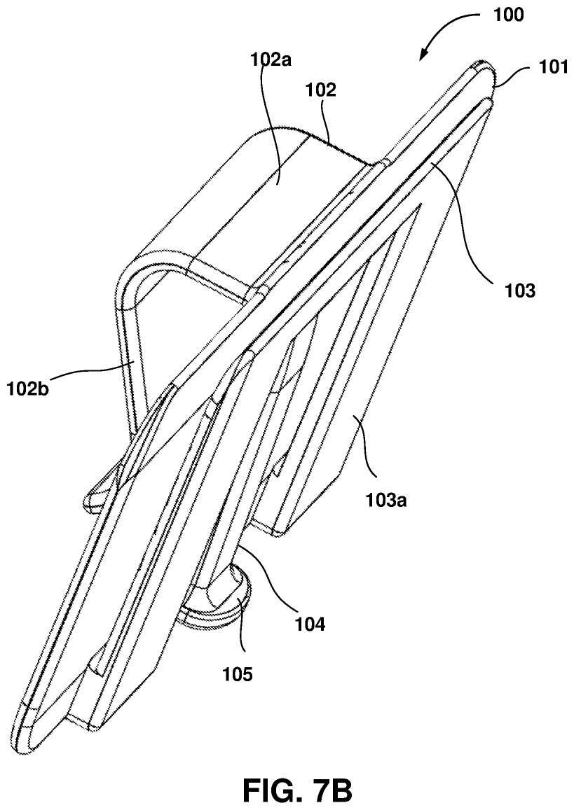

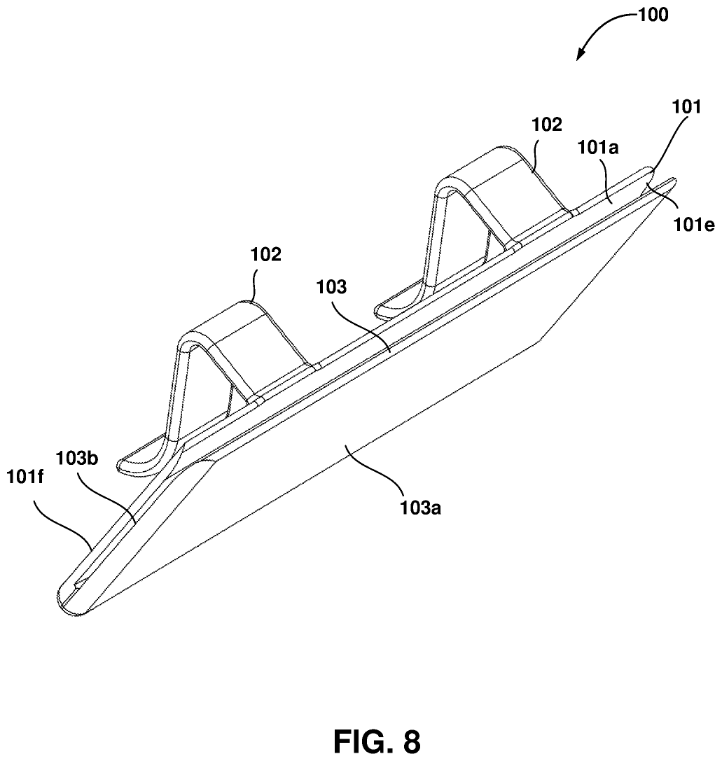

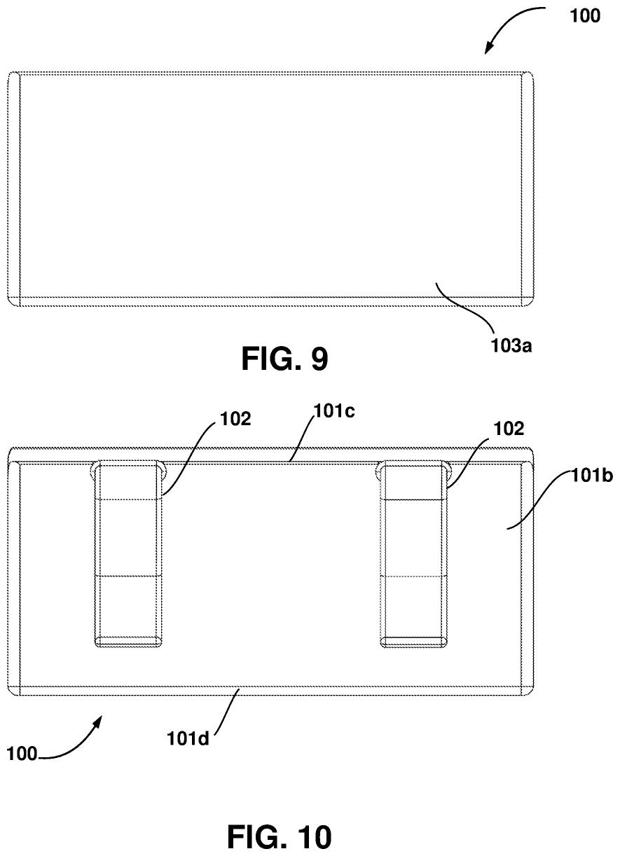

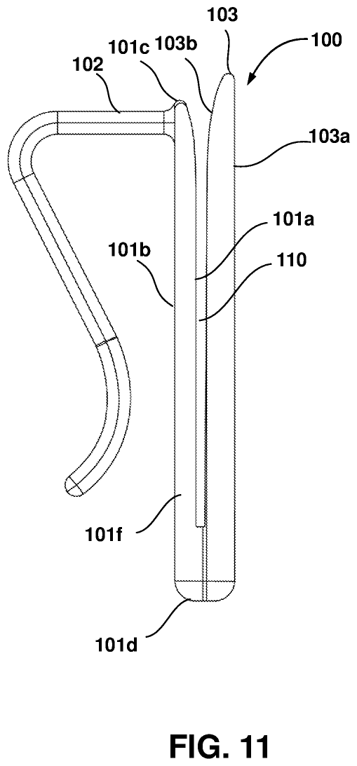

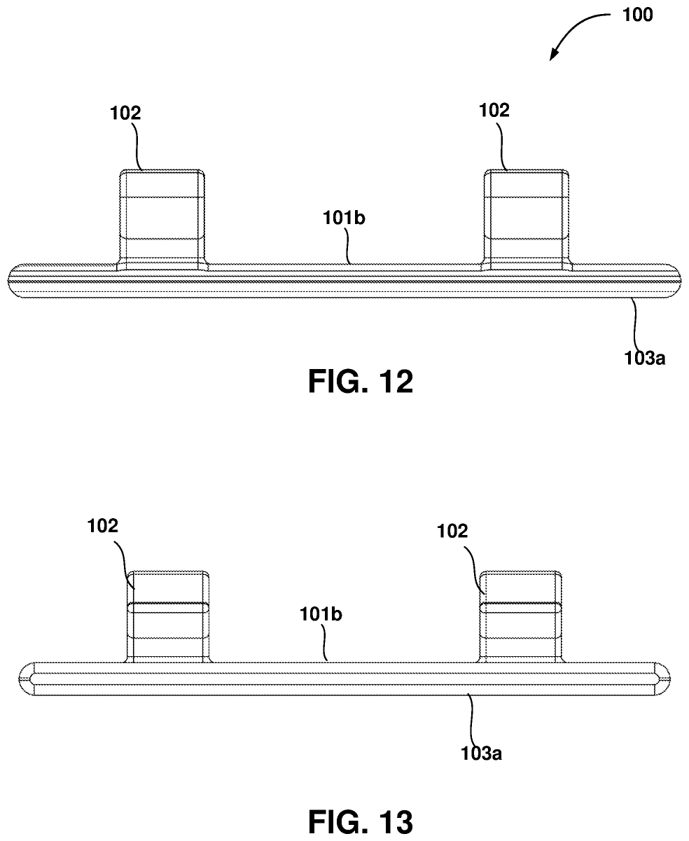

The noval phone holder or a seat belt attachment of the present invention will now be described with reference to the accompanying drawings, which should be regarded as merely illustrative without restricting the scope and ambit of the present invention. Embodiments of the present invention will now be described with reference to FIGS. 1-15.

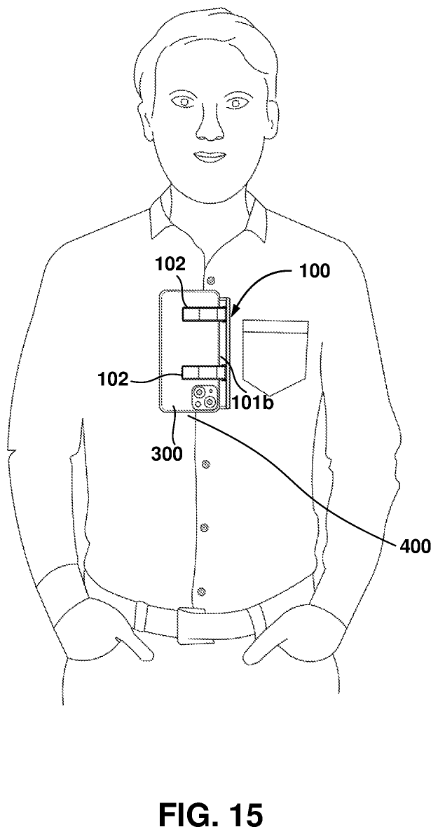

Referring now to the accompanying figures, particularly to FIGS. 1-6, a phone holder 100 removably attachable to a seat belt 200 of an automobile for holding an electronic device is shown. For the purpose of this disclosure, the phone holder 100 is considered as an attachment for attaching to the seat belt 200. However, it should be apparent to a person skilled in the art that the phone holder 100 of the present invention may be attachable to the shirt (FIG. 15), to the straps of the backpack (not seen), or in other like applications. The phone holder 100 has a significant advantage in that the holder allows an electronic phone (such as a mobile phone) to be disposed of near a user's face so that the user can make use of the microphone (mic) of the mobile phone to converse with any other people with lesser hindrance (for example due to automobile sound, winds, or public noises etc.) especially when the user is driving or in public places with lots of disturbances. Cutting short the distance between the phone and the user and not having to hold the phone (that's quite an important rule when driving) are some of the key aspects of the present invention.

Referring to FIGS. 1-6, the phone holder 100 includes a base portion 101. The base portion 101 is substantially planar and have a first surface 101a and an opposed second surface 101b. The base portion 101 further comprises an upper edge 101c and a lower edge 101d, and a pair of side edges 101e, 101f extending between the upper and lower edges 101c, 101d.

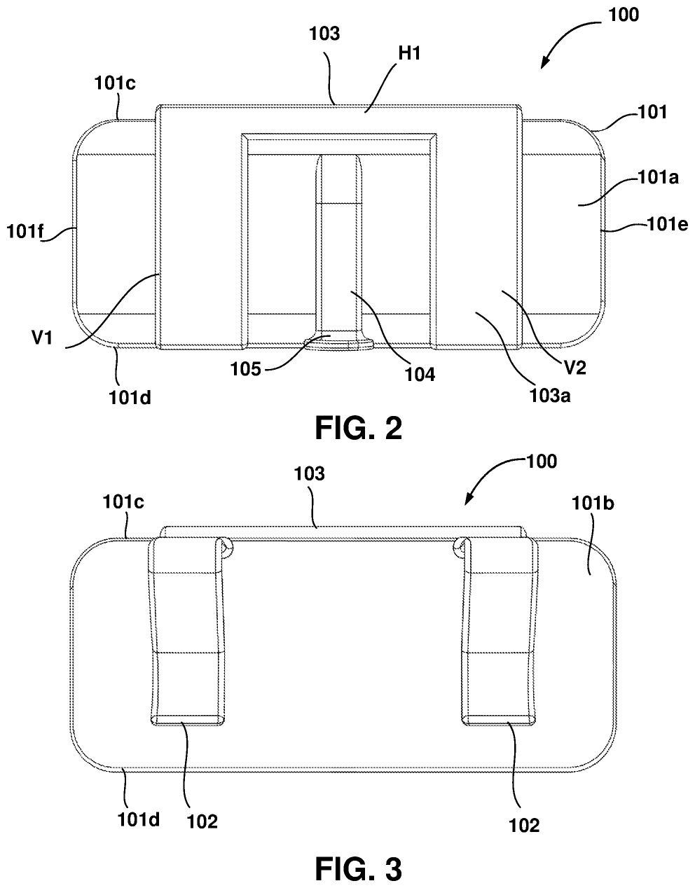

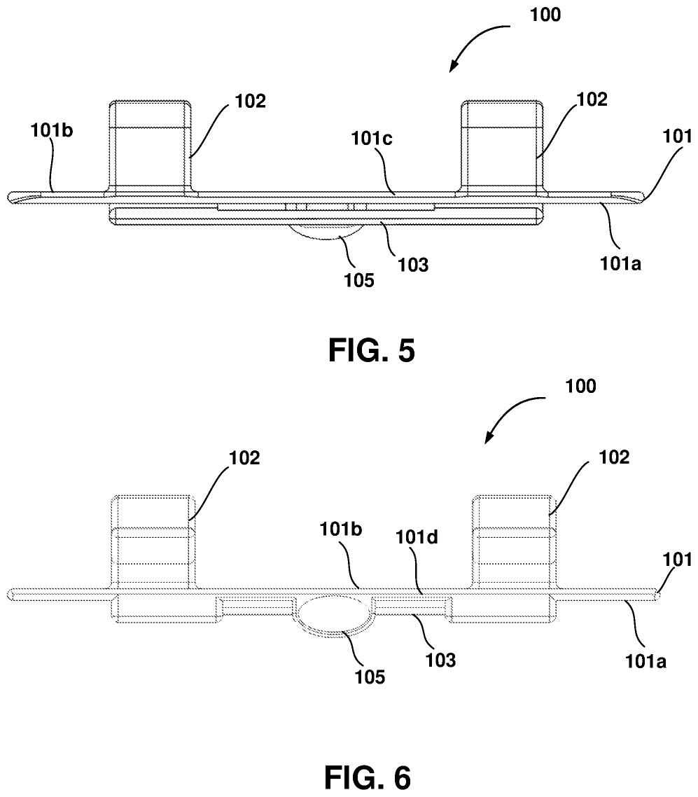

In an embodiment, the base portion 101 of the phone holder 100 is made substantially rectangular in shape with at least rounded corners as seen in FIGS. 1 and 2. In another embodiment, the base portion 101 of the phone holder 100 is made substantially rectangular in shape with pointed corners as seen in FIG. 7A.

In an embodiment, the first surface 101a of the base portion 101 comprises a ramp 104 that extends between the lower edge 101d, and the upper edge 101c. The ramp 104 may extend its entire length along the lower edge 101d to the upper edge 101c according to an embodiment (not seen). In another embodiment, the ramp 104 may extend partially along from the lower edge 101d to the upper edge 101c as best seen in FIG. 2. The ramp 104 may be of any predefined width and may be equal in width or lesser in width when compared to at least one belt clip 103 of the phone holder 100. The ramp 104 is curved or inclined and extends between the lower edge 101d, and the upper edge 101c. Curved or inclined for the purpose of this discloser means that the ramp 104 is thicker at the lower edge 101d and slowly the thickness of the ramp 104 decreases and has minimal thickness at the upper edge 101c of the base portion 101. Further, in an embodiment, the ramp 104 is disposed of in midway between the pair of side edges 101e,101f of the base portion 101.

According to an embodiment, the ramp 104 present on the base portion 101 further comprises a thumb support 105 configured at one end (end proximal to the lower edge 101d). The thumb support 105 facilitates in removal of the clipped-on electronic device or mobile phone 300 from the phone holder 100 when the user needs to take off the phone from the phone holder mounted onto the seat belt 200.

Further, according to an embodiment, as shown in FIGS. 1-6, the phone holder 100 comprises at least one belt clip 103. The belt clip 103 includes an outer surface 103a and an inner surface 103b. The belt clip 103 is fixedly attached in proximity to the lower edge 101d on the first surface 101a of the base portion 101. In an embodiment, the belt clip 103 extends partially between the pair of side edges 101e, and 101f. In an embodiment, the belt clip 103 extends exactly to the height of the base portion 101 (not seen). In another embodiment, the belt clip 103 extends beyond the height of the base portion 101 as best seen in FIGS. 2-4. Further, in an embodiment, the belt clip 103 is U-shaped with formed using two vertical arms (V1, V2) and a horizontal arm (H1) as shown in FIG. 2. Further, the inner surface 103b of the belt clip 103 is curved or inclined just like the ramp 104 discussed above to facilitate tightening of the seat belt 200 between the second surface 101b of the base portion 101 and the clips 102.

Further, according to an embodiment, as shown in FIGS. 1-6, the phone holder 100 comprises a pair of electronic device holder clips 102. Each of the holder clip 102 is fixedly attached in proximity to the upper edge 101c on the second surface 101b of the base portion 101. The holder clips 102 are identical and preferably perfectly aligned along the same line on the second surface 101b of the base portion 101. The electronic device holder clips 102 are configured to retain the electronic device or mobile phone 300 between the second surface 101b of the base portion 101, and a curved inner portion 102b of the electronic device holder clips 102.

Further, each of the holder clips 102 is substantially L-shaped. Each of the holder clips 102 includes an upwardly extending portion 102a, and the curved inner portion 102b as shown in FIG. 4. An end 102c of the upwardly extending portion 102a of each of the holder clips 102 is attached in proximity to the upper end 101c on the second surface 101b of the base portion 101, and an opposing end 102d is connected to the curved inner portion 102b. A trough region 102e of the curved inner portion 102b of each of the holder clips 102 is responsible for exerting pressure and retaining the mobile phone against the second surface 101b of the base portion 101.

In an embodiment, the pair of electronic device holder clips 102 have a flexible configuration that is biased toward an opposed second surface 101b to secure the electronic device 300 between the pair of electronic device holder clips 102 and the second surface 101b of the base portion 101.

In another embodiment, as best seen in FIG. 7B, instead of a pair of electronic device holder clips 102, the phone holder 100 may include just one holder clip 102. The holder clip 102 is substantially similar in design to the clips 102 described above. However, while using a single clip, the clip 102 may be made a little wider to retain the phone 300. The structure and configuration and design characteristics of clip 102 is similar to the clips 102 described above.

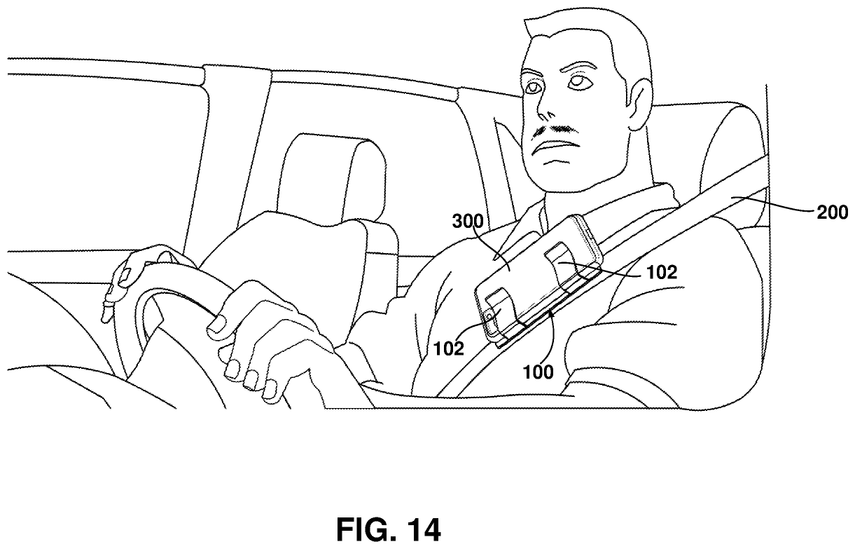

In operation, referring to FIGS. 1-6 and 14, the user of the phone holder 100 passes the seat belt 200 through a slit/opening 110 formed between the first surface 101a of the base portion 101 and the inner surface 103b of the belt clip 103, and adjusts/slides the phone holder 100 to a suitable location near user's face such that the seat belt 200 gets tightly held onto the seat belt 200. The ramp 104 and/or the curve formation on the ramp helps in tightening the seat belt 200 and holding the holder 100 on the seat belt 200 as seen in FIG. 14. In other words, the first surface (101a) of the base portion (101) and the inner surface (103b) of the at least one belt clip (103) are configured to removably secure the phone holder (100) over the seat belt (200), The user then can manipulate flexible pair of electronic device holder clips 102 located on the other side of the base portion in order to slide the mobile phone 300 between the clips 102 and the second surface 101b of the base portion. The trough region 102e of the curved inner portion 102b of each of the holder clips 102 exerts pressure and retains the mobile phone 300 against the second surface 101b of the base portion 101, thereby allowing the user to use the phone's microphone and speaker for speaking and listening to the other user while conversing on a phone call. The phone holder 100 may also be hung/attached to a shirt (FIG. 15) specifically, on a right upper front body area 400 of a shirt worn by the user. For this, the user needs to unbutton shirt in the right upper front body area 400 and the slide in the edge of the shirt within the slit 100 till the holder 100 is tightly held on the shirt (because of the presence of the ramp 104). The user then can manipulate flexible pair of electronic device holder clips 102 located on the other side of the base portion in order to slide the mobile phone 300 between the clips 102 and the second surface 101b of the base portion 101 as shown in FIG. 15.

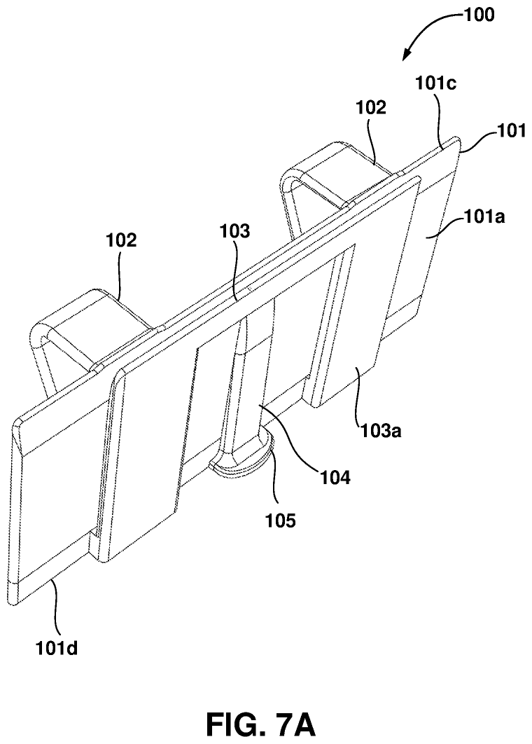

Referring to FIGS. 8-13 essentially shows another alternative embodiment for the phone holder 100. The phone holder 100 shown in FIGS. 8-13 is essentially identical except the variation related to the ramp 104 and the at least one belt clip 103. Unlike the presence of the ramp 104, in this embodiment, the first surface 101a of the base portion 101 is curved or inclined extending from the lower edge 101d to the upper edge 101c between the pair of side edges 101e, 101f. Curved or inclined for the purpose of this discloser means that the surface 101a is thicker at the lower edge 101d and slowly the thickness of the surface 101a decreases and has a minimal thickness at the upper edge 101c of the base portion 101. The curve formation on the surface 101a helps in tightening the seat belt 200 and holding the holder 100 on the seat belt 200. There is no separate ramp 104 disposed on the first surface 101a described with reference to FIGS. 1-6. Further as seen in FIGS. 8,9,12-13, the belt clip 103 in this embodiment extends along the entire length between the pair of side edges 101e, 101f of the base portion 101 unlike the belt clip 103 that extends partially along between the pair of side edges 101e, 101f. Further, the belt clip 103 in this embodiment is flat and substantially similar in shape to that of the base portion 101. In operation, the phone holder 100 of FIGS. 8-13, operates in the same manner as that described above.

The phone holder 100 and the various parts discussed above may be made as a unitary product using injection molding or similar processes known in the art. It should be noted that the phone holder 100 may be made such that the parts base portion 101, pair of electronic device holder clips (102), and at least one belt clip (103) may be removably or fixedly attached. Further, depending upon the size of the electronic device 300 to be held on the phone holder 100, the phone holder 100 may be made in various sizes using a variety of materials such as plastic, silicon, and so on known in the art.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A phone holder (100) removably attachable to a seat belt (200) for holding an electronic device (300), comprising:
a base portion (101) substantially planar and having a first surface (101a) and an opposed second surface (101b), wherein the base portion (101) further comprises an upper edge (101c) and a lower edge (101d), and a pair of side edges (101e,101f) extending between the upper and lower edges (101c, 101d);
at least one electronic device holder clip (102), the at least one electronic device holder clip (102) is fixedly attached in proximity to the upper edge (101c) on the second surface (101b), the at least one electronic device holder clip (102) is configured to retain the electronic device (300) between the second surface (101b) of the base portion (101), and a curved inner portion (102b) of the electronic device holder clip (102);
at least one belt clip (103) with an outer surface (103a) and an inner surface (103b), wherein the at least one belt clip (103) is fixedly attached in proximity to the lower edge (101d) on the first surface (101a); and
wherein, the first surface (101a) of the base portion (101) and the inner surface (103b) of the at least one belt clip (103) are configured to removably secure the phone holder (100) over the seat belt (200), when the seat belt (200) is passed therethrough.

2. The phone holder of claim 1, wherein the base portion (101) is substantially rectangular in shape with at least rounded corners or pointed corners.

3. The phone holder of claim 1, wherein the at least one electronic device holder clip (102) have a flexible configuration that is biased toward an opposed second surface (101b) to secure the electronic device (300) between the pair of electronic device holder clips (102) and the second surface (101b) of the base portion (101).

4. The phone holder of claim 1, wherein the first surface (101a) of the base portion (101) is curved or inclined extending from the lower edge (101d) to the upper edge (101c) between the pair of side edges (101e,101f).

5. The phone holder of claim 1, wherein the first surface (101a) of the base portion (101) comprises a ramp (104) configured thereon.

6. The phone holder of claim 5, wherein the ramp (104) is curved or inclined and extends between the lower edge (101d), and the upper edge (101c).

7. The phone holder of claim 6, wherein the ramp (104) is thicker at the lower edge (101d) and thinner at the upper edge (101c) of the base portion (101).

8. The phone holder of claim 5, wherein the ramp (104) is disposed of in midway between the pair of side edges (101e,101f).

9. The phone holder of claim 6, wherein the ramp (104) further comprises a thumb support (105) configured at one end thereof to facilitate removal of the clipped-on electronic device (300) from the phone holder (100).

10. The phone holder of claim 1, wherein the at least one belt clip (103) extends along the entire length between the pair of side edges (101e,101f).

11. The phone holder of claim 1, wherein the at least one belt clip (103) extends partially along between the pair of side edges (101e,101f).

12. The phone holder of claim 1, wherein the at least one belt clip (103) extends exact to the height of the base portion (101).

13. The phone holder of claim 1, wherein the at least one belt clip (103) extends beyond the height of the base portion (101).

14. The phone holder of claim 1, wherein the at least one belt clip (103) is at least substantially flat and substantially similar in shape to that of the base portion (101).

15. The phone holder of claim 1, wherein the at least one belt clip (103) is U-shaped with formed using two vertical arms (V1, V2) and a horizontal arm (H1).

16. The phone holder of claim 1, wherein the at least one electronic device holder clip (102) is substantially L-shaped and comprises an upwardly extending portion (102a), and the curved inner portion (102b).

17. The phone holder of claim 16, wherein an end (102c) of the upwardly extending portion (102a) of each of the pair of holder clips (102) is attached in proximity to the upper end (101c) on the second surface (101b), and an opposing end (102d) is connected to the curved inner portion (102b).

18. A phone holder (100) removably attachable to a seat belt (200) for holding an electronic device (300), comprising:
a base portion (101) substantially planar and having a first surface (101a) and an opposed second surface (101b), wherein the base portion (101) further comprises an upper edge (101c) and a lower edge (101d), and a pair of side edges (101e,101f) extending between the upper and lower edges (101c, 101d);
a pair of electronic device holder clips (102), each of the pair of holder clips (102) is fixedly attached in proximity to the upper edge (101c) on the second surface (101b), each of the pair of electronic device holder clips (102) is configured to retain the electronic device (300) between the second surface (101b) of the base portion (101), and a curved inner portion (102b) of the electronic device holder clips (102);
at least one belt clip (103) with an outer surface (103a) and an inner surface (103b), wherein the at least one belt clip (103) is fixedly attached in proximity to the lower edge (101d) on the first surface (101a); and
wherein, the first surface (101a) of the base portion (101) and the inner surface (103b) of the at least one belt clip (103) are configured to removably secure the phone holder (100) over the seat belt (200), when the seat belt (200) is passed therethrough.

19. The phone holder of claim 18, wherein the at least one belt clip (103) is U-shaped with formed using two vertical arms (V1, V2) and a horizontal arm (H1).

20. The phone holder of claim 18, wherein the first surface (101a) of the base portion (101) comprises a ramp (104) configured thereon.
